(19) United States
(12) Patent Application Publication
(10) Pub. No.: US 2026/0036442 A1
(43) Pub. Date: Feb. 5, 2026

(54) INPUT DEVICE AND ROTATION DETECTION DEVICE OF THE SAME

(71) Applicant: Alps Alpine Co., Ltd., Tokyo (JP)

(72) Inventors: Masaki OTA, Miyagi-ken (JP); Tetsu NUMATA, Miyagi-ken (JP); Takenori TAKAHASHI, Miyagi-ken (JP); Masatoshi ONO, Miyagi-ken (JP); Kunji SASAKI, Dalian (CN); Jilong WANG, Dalian (CN); Yingxu SUN, Dalian (CN)

(21) Appl. No.: 19/277,889

(22) Filed: Jul. 23, 2025

(30) Foreign Application Priority Data
Aug. 2, 2024 (CN) 202411056791.X

(51) Int. Cl. G01D 5/241; G01B 7/30

(52) U.S. Cl. CPC G01D 5/2415; G01B 7/30; G01D 2205/20; G01D 2205/50; G01D 2205/775

(57) ABSTRACT

An embodiment of the present disclosure relates to an input device and a method of manufacturing the input device. The input device according to the embodiment includes a main housing including a metal side plate, an interlocking unit pivotably provided in the main housing, and a rotation detection device configured to detect a rotation angle of the interlocking unit, wherein the rotation detection device includes a housing, a sensor electrode provided in the housing, a reference electrode facing the sensor electrode, a movable plate rotatably provided in the housing so as to be disposed between the sensor electrode and the reference electrode, and a shield plate provided on an outer wall of the housing, and wherein the shield plate is connected to a metal side plate of the main housing.

### CLAIM OF PRIORITY

This application claims benefit of Chinese Patent Application No. 202411056791. X filed on Aug. 2, 2024, which is hereby incorporated by reference.

### BACKGROUND OF THE INVENTION

### 1. Field of the Invention

The present disclosure relates to an input device and a rotation detection device thereof.

### 2. Description of the Related Art

Currently, a multi-directional input device that operates a plurality of electrical members with a single operation shaft that can move in a plurality of directions is publicly known. In such a multi-directional input device, examples of the sensor that detects the movement of the operation shaft include an electrical resistance sensor, a magnetic sensor, and an electrostatic sensor. Among them, the electrostatic sensor can eliminate the problem of a resistance drift of an electrical resistance unlike the electrical resistance sensor, and does not require a magnet or a Hall element to be installed unlike the magnetic sensor, so that the electrostatic sensor can achieve detection of a non-contact motion with a simpler structure and lower cost. In addition, electrostatic sensors can further implement additional functions based on static electricity, for example, touch detection, pressure detection, an encoder, and a touch panel. Therefore, electrostatic motion sensors are widely applied to various devices that detect minute movements, such as, for example, multi-directional input devices.

For example, Japanese Unexamined Patent Application Publication No. 07-055500 discloses a variable capacitive transducer (sensor) configured to detect the position of a movable member, the variable capacitive transducer including a first stationary conductive source surface connected to an oscillating source of electrical energy, a second stationary surface including a plurality of conductive detection regions spaced apart from the first stationary conductive source surface and disposed to co-operate with the first stationary conductive source surface, a third movable conductive surface connected to the movable member and disposed between the first stationary conductive source surface and a plurality of detection regions and formed to restrict the amount of electrical energy transferred from the first stationary conductive source surface to the plurality of detection regions in direct response to the relative position of the third movable conductive surface relative to the second stationary surface, an electrical connection circuit connected to the detection regions and the third movable conductive surface and maintaining the detection regions and the third movable conductive surface at substantially the same potential, an electrical measurement circuit connected to each of the detection regions and measuring the relative position of the third movable conductive surface based on the amount of energy received by the individual detection regions, and an electrical control circuit connected in a feedback configuration to the source and the electrical measurement circuit and controlling the amount of energy given by the source to the first stationary conductive source surface based on the amount of energy received by the detection regions.

However, in Japanese Unexamined Patent Application Publication No. 07-055500, this variable capacitive transducer (sensor) does not include a shielding material, so that the variable capacitive transducer (sensor) is easily affected by noise. In the variable capacitive transducer (sensor), the third movable conductive surface, the first stationary conductive source surface and the second stationary surface are required to be connected to an electrical circuit, as shown in FIGS. 1 and 7, so that the circuit structure is complex. In addition, the variable capacitive transducer (sensor) is required to perform detection for all angles, or 360°, and one side of the third movable conductive surface is required to be provided at about 90°, thereby making the structure larger or heavier and more costly. In addition, as shown in FIG. 11, the variable capacitive transducer (sensor) is required to be fixed with the 103 screw, which requires a large number of members and a large manufacturing and assembly process, and the screw tend to loosen to easily generate noise and cause an unstable position, resulting in low measurement accuracy and poor stability.

### SUMMARY OF THE INVENTION

The present disclosure solves the above technical problems, and provides an input device and a rotation detection device thereof that can improve the accuracy of measurement and the stability of measurement, simplify the structure, achieve downsizing, simplify the process of manufacturing and assembling, and reduce costs.

The input device according to the present disclosure includes a main housing including a metal side plate, an interlocking unit pivotably provided in the main housing, and a rotation detection device configured to detect a rotation angle of the interlocking unit, wherein the rotation detection device includes a housing, a sensor electrode provided in the housing, a reference electrode facing the sensor electrode, a movable plate rotatably provided in the housing so as to be disposed between the sensor electrode and the reference electrode, and a shield plate provided on an outer wall of the housing, and wherein the shield plate is connected to a metal side plate of the main housing.

According to the input device according to the present disclosure above, it is easy to ground the shield plate by providing the shield plate and connecting the shield plate to the metal side plate of the main housing of the input device. Moreover, it is not necessary to provide a dedicated through-hole for grounding the rotation detection device on the circuit board to which the input device is attached, thereby simplifying the process of manufacturing and assembling the input device and reducing costs.

In the input device according to the present disclosure, the shield plate includes the mounting leg, and the mounting leg engages with the metal side plate, of the main housing, having a bent distal end with the shield plate being connected to the metal side plate of the main housing.

According to the input device according to the present disclosure above, it is possible to easily attach the shield plate and simplify the process of assembling the input device.

In the input device according to the present disclosure, the housing has a protrusion on a surface of an outer wall on which the shield plate is provided, wherein the shield plate has a hole at a position corresponding to the protrusion.

According to the input device according to the present disclosure above, the protrusion on the outer wall of the housing and the hole, in the shield plate, corresponding to the protrusion allow easy positioning of the shield plate and the housing, simple mounting of the shield plate, and simplification of the process of assembling the input device.

In the input device according to the present disclosure, the shield plate includes a positioning portion, wherein the housing has a positioning hole at a position corresponding to the positioning portion.

According to the input device according to the present disclosure above, the positioning portion of the shield plate and the positioning hole, in the housing, corresponding to the positioning portion allow easy positioning of the shield plate and the housing, simple mounting of the shield plate, and simplification of the process of assembling the input device.

The input device according to the present disclosure further includes a measurement IC including an AC signal source and an operational amplifier, wherein the reference electrode is electrically connected to one terminal of the operational amplifier and the AC signal source, wherein the sensor electrode is electrically connected to the other terminal of the operational amplifier, and wherein the movable plate is attached to the housing via a resin-made rotation shaft, and is not electrically connected to any other members.

The input device according to the present disclosure further includes a measurement IC including an operational amplifier and an AC signal source electrically connected to one terminal of the operational amplifier, wherein the reference electrode is grounded, wherein the sensor electrode is electrically connected to the other terminal of the operational amplifier, and wherein the movable plate is attached to the housing via a resin-made rotation shaft and is not electrically connected to any other members.

According to the input device according to the present disclosure above, the movable plate is attached to the housing via the rotation shaft and is not electrically connected to any other members, thereby being able to eliminate the need for a structure to electrically connect the movable plate, simplify the mounting structure of the movable plate and the process of manufacturing and assembling, easily achieve downsizing of the rotation detection device and the input device, and reduce costs.

In the input device according to the present disclosure, the sensor electrode includes four annular fan-shaped sub-electrodes divided from an annular ring, wherein the four sub-electrodes are disposed along a circumference with a gap between adjacent sub-electrodes, wherein sub-electrodes, of the four sub-electrodes, that are not circumferentially adjacent to each other are electrically connected, wherein the movable plate has a shape in which two fan-shaped plates whose arc portions face to each other in opposite directions are connected to each other, and wherein a center angle of the movable plate is greater than 55° and less than 85°.

In the input device according to the present disclosure, a gap between adjacent sub-electrodes includes a gap that does not overlap the movable plate and a gap that overlaps the movable plate, wherein the gap that does not overlap the movable plate is larger than the gap that overlaps with the movable plate.

According to the input device according to the present disclosure above, it is possible to make the size of the movable plate appropriate, improve the accuracy of measurement, reduce the costs, and easily achieve downsizing of the device.

In the input device according to the present disclosure, the sensor electrode is insert molded into the housing so that a surface, of the sensor electrode, opposite a surface, of the sensor electrode, facing the movable plate and an annular inner edge and an annular outer edge of the surface facing the movable plate are covered by the housing.

In the input device according to the present disclosure, the reference electrode is an annular metal plate, wherein the reference electrode is insert molded into the housing so that a surface, of the reference electrode, opposite a surface, of the reference electrode, facing the movable plate and an annular inner edge and an annular outer edge of the surface facing the movable plate are covered by the housing.

According to the input device according to the present disclosure above, since the sensor electrode and/or the reference electrode are insert molded into a resin-made housing so as to be partially exposed, the sensor electrode and/or the reference electrode can be stably fixed to the housing without the need for screws or other fixing materials, thereby reducing the number of members and costs and facilitating the process of manufacturing and assembling, hardly generating noise, making the position of the sensor electrode and/or the reference electrode stable, and capable of performing measurement with high accuracy of and excellent stability.

In the input device according to the present disclosure, a half or more of an area of a surface, of the sensor electrode, facing the movable plate is not covered by the housing.

In the input device according to the present disclosure, a half or more of an area of a surface, of the reference electrode, facing the movable plate is not covered by the housing.

According to the input device according to the present disclosure above, since a half or more of an area of the sensor electrode and/or the reference electrode is fixed to the mold during insert molding, the position of the sensor electrode and/or the reference electrode is stable, noise is hardly generated, and measurement with high accuracy of and excellent stability can be performed.

In the input device according to the present disclosure, a thickness of the housing covering an annular inner edge of a surface, of the sensor electrode, facing the movable plate in a direction along the rotation shaft is greater than a thickness of the housing covering an annular outer edge of the surface, of the sensor electrode, facing the movable plate.

In the input device according to the present disclosure, a thickness of the housing covering an annular inner edge of a surface, of the reference electrode, facing the movable plate in a direction along the rotation shaft is greater than a thickness of the housing covering an annular outer edge of the surface, of the reference electrode, facing the movable plate.

According to the input device according to the present disclosure above, by making the thickness of the housing covering the annular inner edge larger than the thickness of the housing covering the annular outer edge, it is possible to securely hold the movable plate, prevent the axial movement of the movable plate, and prevent contact between the movable plate and other resin components.

In the input device according to the present disclosure, the metal side plate of the main housing is grounded and the sensor electrode is disposed closer to the main housing than the reference electrode.

According to the input device according to the present disclosure above, the main housing is securely grounded and the sensor electrode is disposed closer to the securely grounded main housing, further improving the accuracy of the measurement.

In the input device according to the present disclosure, the interlocking unit includes a first interlocking unit pivotably provided in the main housing and a second interlocking unit pivotably provided in the main housing in a direction orthogonal to the first interlocking unit, wherein the rotation detection device includes a first rotation detection device that detects a rotation angle of the first interlocking unit and a second rotation detection device that detects a rotation angle of the second interlocking unit.

According to the input device according to the present disclosure above, movements in a plurality of directions can be detected with high accuracy.

The rotation detection device according to the present disclosure includes a housing, a sensor electrode provided in the housing, a movable plate rotatably provided in the housing, and an annular reference electrode, wherein the sensor electrode includes four annular fan-shaped sub-electrodes divided from an annular ring, wherein the four sub-electrodes are disposed along a circumference with a gap between adjacent sub-electrodes, wherein sub-electrodes, of the four sub-electrodes, that are not circumferentially adjacent to each other are electrically connected to each other, wherein the movable plate has a shape in which two fan-shaped plates whose arc portions face to each other in opposite directions are connected to each other, wherein a center angle of the movable plate is greater than 55° and less than 85°, wherein a gap between adjacent sub-electrodes includes a gap that does not overlap the movable plate and a gap that overlaps the movable plate, and wherein the gap that does not overlap the movable plate is larger than the gap that overlaps the movable plate.

According to the rotation detection device according to the present disclosure above, it is possible to make the size of the movable plate appropriate, improve the accuracy of measurement, reduce costs, and easily achieve downsizing of the device.

The rotation detection device according to the present disclosure includes a housing, a sensor electrode provided in the housing, a movable plate rotatably provided in the housing, and an annular reference electrode, wherein the sensor electrode includes four annular fan-shaped sub-electrodes divided from an annular ring, wherein the four sub-electrodes are disposed along a circumference with a gap between adjacent sub-electrodes, wherein sub-electrodes, of the four sub-electrodes, that are not circumferentially adjacent to each other are electrically connected to each other, wherein the movable plate has a shape in which two fan-shaped sub-electrodes whose arc portions face to each other in opposite directions are connected, wherein the reference electrode is insert molded into the housing so that a surface, of the reference electrode, opposite a surface, of the reference electrode, facing the movable plate and an annular inner edge and an annular outer edge of the surface facing the movable plate are covered by the housing, and wherein the sensor electrode is insert-molded into the housing so that a surface, of the sensor electrode, opposite a surface, of the sensor electrode, facing the movable plate and an annular inner edge and an annular outer edge of the surface facing the movable plate are covered by the housing.

According to the rotation detection device according to the present disclosure above, since the reference electrode and the sensor electrode are insert molded into a resin-made housing so as to be partially exposed, the reference electrode and the sensor electrode can be stably fixed to the housing without the need for screws or other fixing materials, thereby reducing the number of members and costs and facilitating the process of manufacturing and assembling, hardly generating noise, making the position of the sensor electrode and/or the reference electrode stable, and capable of performing measurement with high accuracy of and excellent stability.

### BRIEF DESCRIPTION OF THE DRAWINGS

FIG. 1A is a three-dimensional view of the partial structure of the input device according to the first embodiment of the present disclosure;

FIG. 1B is an exploded three-dimensional view of the partial structure of the input device according to the first embodiment of the present disclosure;

FIG. 1C is an exploded three-dimensional view of the rotation detection device of the input device according to the first embodiment of the present disclosure;

FIG. 1D is a three-dimensional view of another partial structure of the input device according to the first embodiment of the present disclosure;

FIG. 2A is a three-dimensional view of the partial structure of the input device according to the second embodiment of the present disclosure;

FIG. 2B is an exploded three-dimensional view of the partial structure of the input device according to the second embodiment of the present disclosure;

FIGS. 2C to 2F are exploded three-dimensional views of the rotation detection device of the input device according to the second embodiment of the present disclosure;

FIGS. 3A to 3B are schematic diagrams of the fixing structure of the shield plate of the rotation detection device of the input device according to the present disclosure;

FIGS. 4A to 4B are schematic diagrams of an example of the positioning structure of the shield plate of the rotation detection device of the input device according to the present disclosure;

FIG. 4C is a schematic diagram of another example of the shield plate of the rotation detection device of the input device according to the present disclosure;

FIG. 5A is a schematic diagram of an example of the circuit connection structure of the rotation detection device of the input device according to the present disclosure;

FIG. 5B is a schematic diagram of another example of the circuit connection structure of the rotation detection device of the input device according to the present disclosure;

FIG. 6A is a schematic diagram of an example of the shape of the sensor electrode and the movable plate of the rotation detection device of the input device according to the present disclosure;

FIG. 6B is a schematic diagram of another example of the shape of the sensor electrode and the movable plate of the rotation detection device of the input device according to the present disclosure;

FIG. 7 is a schematic diagram of another example of the shape of the sensor electrode and the movable plate of the rotation detection device of the input device according to the present disclosure;

FIG. 8 is a cross-sectional view of an example of the formation method of the reference electrode and the sensor electrode of the rotation detection device of the input device according to the present disclosure;

FIG. 9 is a three-dimensional view of the partial structure of the input device according to the third embodiment of the present disclosure; and

FIG. 10 is a three-dimensional view of an example of the partial structure of the input device according to the present disclosure.

### DESCRIPTION OF THE PREFERRED EMBODIMENTS

The input device and its rotation detection device according to the present disclosure will be described in detail below with reference to the drawings.

In the drawings, only members related to the technical ideas of the disclosure are shown, and other members are omitted. The drawings are illustrative or conceptual, and the dimensions of each component, the ratio of dimensions between components, and the like, may not necessarily be identical to the actual ones. Even when the same components are represented, the dimensions and proportions of the components may differ depending on the drawing.

In the specification and each drawing of this application, the same reference sign is used for members that perform the same or similar functions. The same reference sign is used for an element that is identical to that described above for figures that have already appeared, and detailed explanations are appropriately omitted.

### First Embodiment

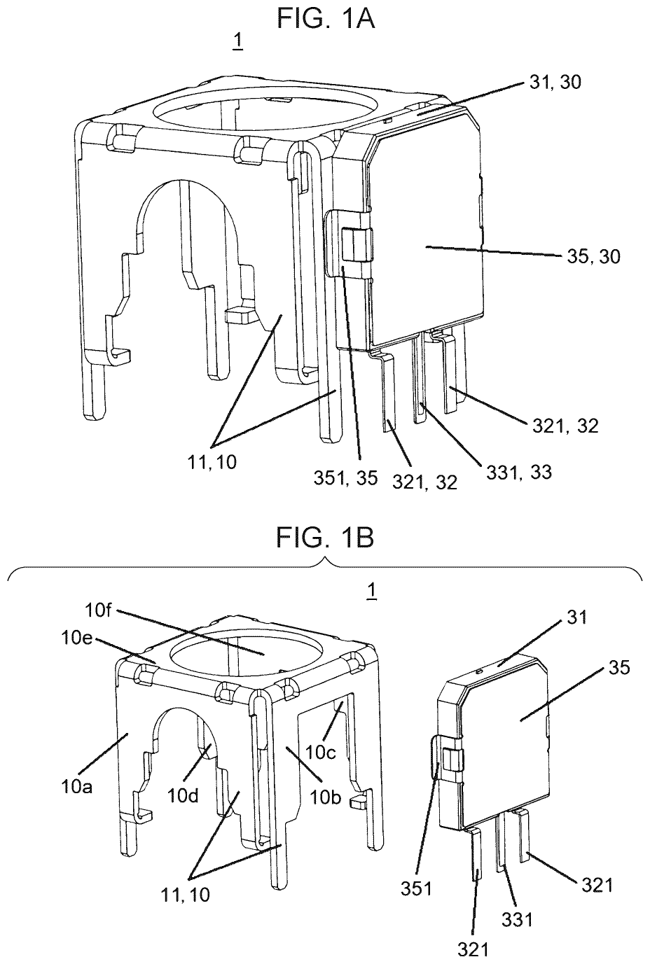

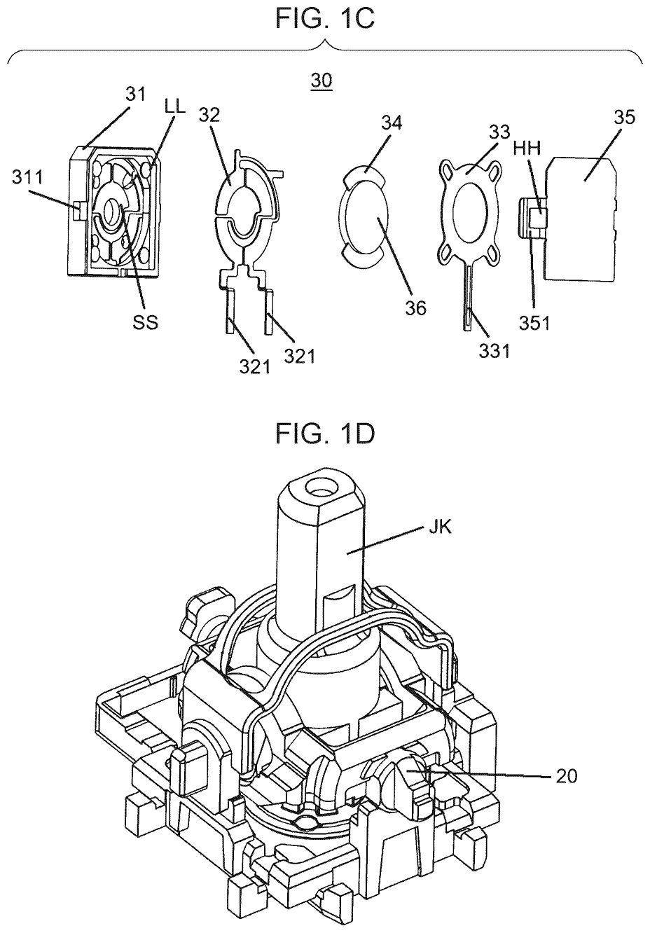

In the following, the input device according to the first embodiment is described, mainly referring to FIGS. 1A to 1D. FIG. 1A is a three-dimensional view of the partial structure of the input device according to the first embodiment of the present disclosure. FIG. 1B is an exploded three-dimensional view of the partial structure of the input device according to the first embodiment of the present disclosure. FIG. 1C is an exploded three-dimensional view of the rotation detection device of the input device according to the first embodiment of the present disclosure. FIG. 1D is a three-dimensional view of another partial structure of the input device according to the first embodiment of the present disclosure.

As shown in FIGS. 1A to 1C, an input device 1 according to the present embodiment includes a main housing 10 that includes a metal frame 11. Here, the main housing 10 is formed by refracting a steel sheet (metal plate) or the like by pressing or the like. The metal frame 11 included in the main housing 10 includes a top plate 10e and four metal side plates 10a, 10b, 10c, and 10d, and is hollow inside and nearly rectangular in shape with an open bottom. The center of the top plate 10e has a circular operation hole 10f. Here, the metal side plates 10a, 10b, 10c, and 10d of the main housing 10 are grounded.

As shown in FIG. 1B, each of the metal side plates 10a, 10b, 10c, and 10d has a hole. This hole allows, for example, other members, such as a rotation detection member 30 to be accommodated and to be mounted. The hollow interior and the operation hole 10f of the main housing 10 allows, for example, an interlocking unit 20, an operation shaft JK, and other members as shown in FIG. 1D to be accommodated and to be mounted.

The input device 1 according to the present embodiment includes the interlocking unit 20 that is pivotably provided in the main housing 10. The input device 1 according to the present embodiment includes a rotation detection device 30. The rotation detection device 30 is directly attached to one metal side plate, for example, of the main housing 10, or attached by a mounting member, connected to the interlocking unit, and detects the rotation angle of the interlocking unit. Although the situation is shown in which one rotation detection device 30 is included, two rotation detection devices 30 are normally disposed on the metal side plate of the main housing 10 to detect tilt in all directions.

As shown in FIG. 1C, the rotation detection device 30 includes a housing 31, a sensor electrode 32 provided in the housing 31, a reference electrode 33 facing the sensor electrode 32, a movable plate 34 disposed between the sensor electrode 32 and the reference electrode 33 and provided rotatably in the housing 31, and a shield plate 35 provided on the outer wall of the housing 31. Here, as shown in FIG. 1A, in the input device 1 according to the present embodiment, the shield plate 35 is connected to the metal frame 11 of the main housing 10. Here, the shield plate 35 is made of, for example, a metallic material.

Here, the housing 31 has an approximately box-like shape, made of resin, with an opening and has a space SS in which the sensor electrode 32, the reference electrode 33, the movable plate 34, and the shield plate 35 are accommodated with the sensor electrode 32, the reference electrode 33, the movable plate 34, and the shield plate 35 being attached to one side of the housing 31. The sensor electrode 32, the movable plate 34, the reference electrode 33, and the shield plate 35 are accommodated and mounted in the space SS in this order, for example, but the order is not limited to this order.

The sensor electrode 32 is, for example, provided in the space SS so as to fit into the housing 31. Here, the sensor electrode 32 has a leg 321 for attaching the sensor electrode 32 to a substrate SP (FIG. 10 below). The leg 321 may be formed as part of the sensor electrode 32, or may be formed separated from the sensor electrode 32.

The reference electrode 33 faces the sensor electrode 32 with the movable plate 34 being interposed between the reference electrode 33 and the sensor electrode 32. The reference electrode 33 is attached to the housing 31, for example, by a mounting member LL of the housing 31. The mounting member may be a screw, for example. Alternatively, the mounting member may be a resin-made protrusion, which may engage with a mounting hole formed in the reference electrode 33. Here, the reference electrode 33 has a leg 331 for attaching the reference electrode 33 to the substrate SP (FIG. 10 below). The leg 331 may be formed as part of the reference electrode 33, or may be formed separated from the reference electrode 33. FIGS. 1A to 1C shows a situation in which one leg 331 is included, but the present disclosure is not limited to this, and the number of the legs may be any number.

The movable plate 34 is, for example, metallic and is mounted in the space SS of the housing 31 via a resin-made rotation shaft 36 and is disposed between the sensor electrode 32 and the reference electrode 33. As the rotation shaft 36 rotates in conjunction with the interlocking unit, the movable plate 34 rotates with the rotation of the rotation shaft 36, the area where the sensor electrode 32 and the reference electrode 33 overlap with each other is changed, resulting in changing the electrical capacitance formed by the sensor electrode 32 and the reference electrode 33. With this configuration, a change in electrical capacitance is detected to detect the rotation angle of the interlocking unit, and thereby detecting the movement of the operation shaft that prompts the movement of the interlocking unit.

The shield plate 35 seals the opening of the housing 31 so as to cover the sensor electrode 32, the movable plate 34, and the reference electrode 33, which are accommodated and mounted in the space SS of the housing 31. Here, the shield plate 35 includes a mounting leg 351, and the shield plate 35 is connected to the metal frame 11 of the main housing 10 by the mounting leg 351. The mounting leg 351 of the shield plate 35 has a hole HH. The shield plate 35 is secured and retained in the housing 31 when the hole HH engages with a mounting portion 311 of the housing 31. The mounting leg 351 of the shield plate 35 are formed so that the mounting leg 351 contact the side plate of the main housing 10, that is, the metal frame 11, when the rotation detection device 30 is attached to the side plate of the main housing 10 after being fixed to and retained by the housing 31.

Thus, according to the input device 1 according to the present embodiment, it is easy to ground the shield plate 35 by providing the shield plate 35 and connecting the shield plate 35 to the metal frame 11 of the main housing 10 of the input device 1. And it is not necessary to provide a dedicated through-hole for grounding the rotation detection device in the circuit board to which the input device 1 is to be attached, thereby simplifying the process of manufacturing and assembling the input device 1 and reducing costs.

### Second Embodiment

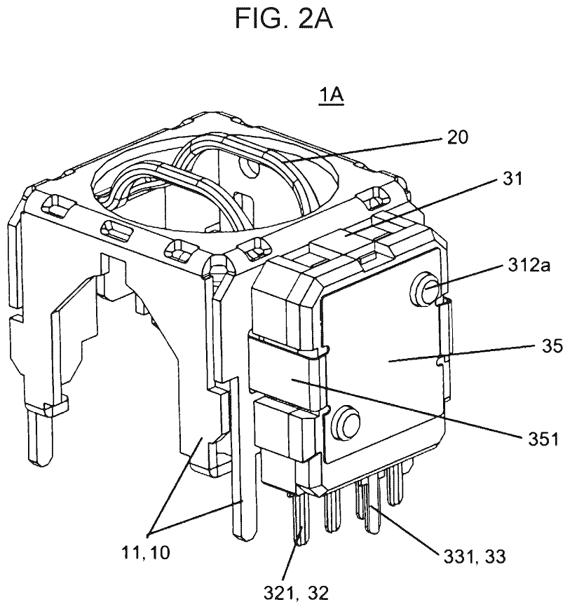

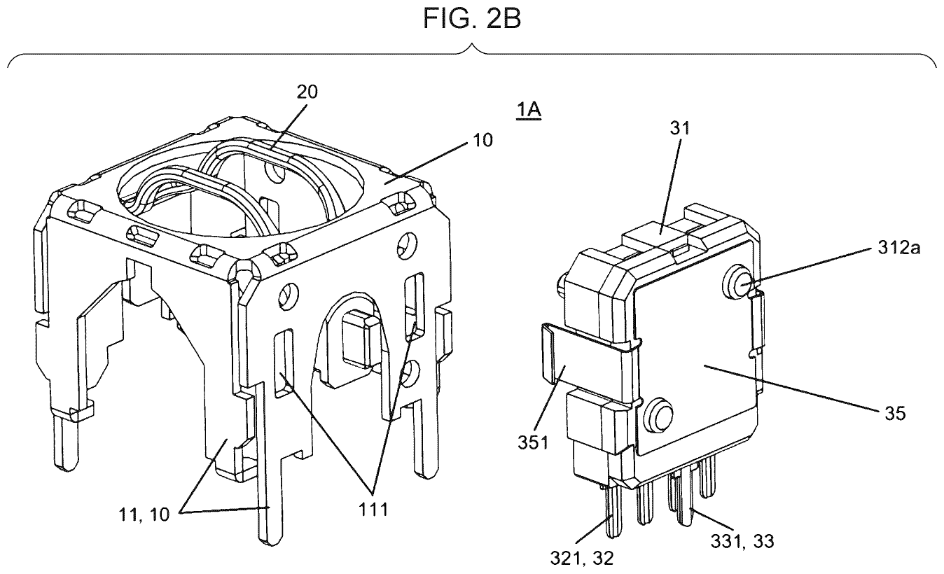

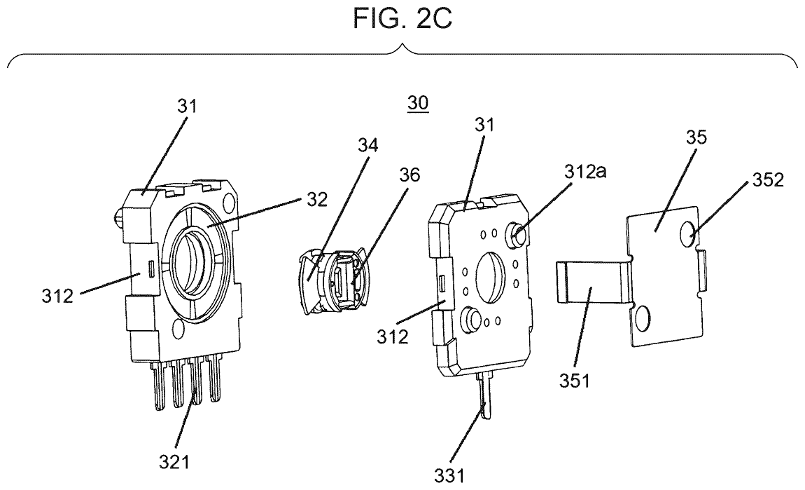

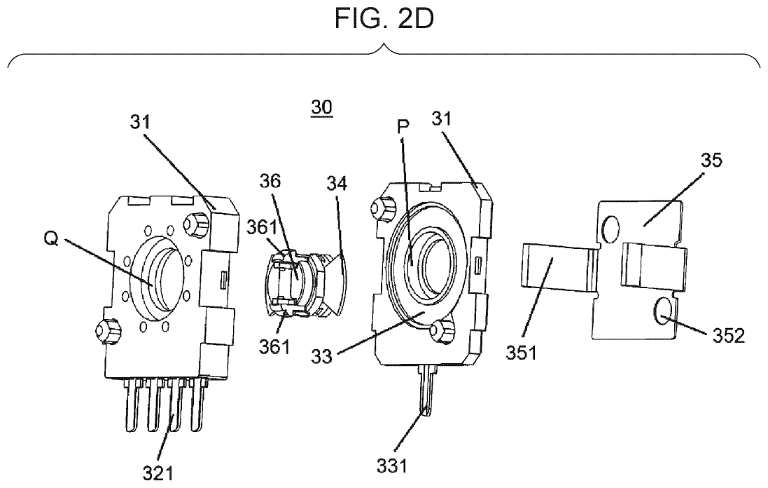

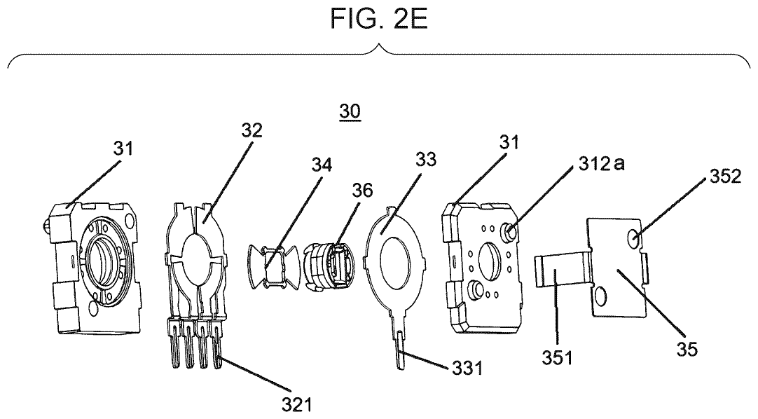

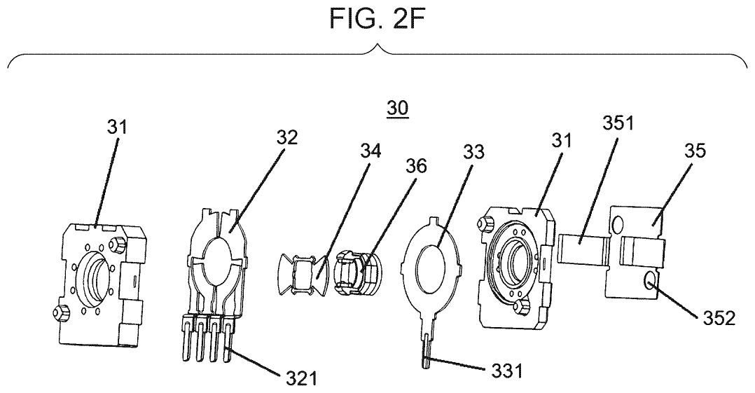

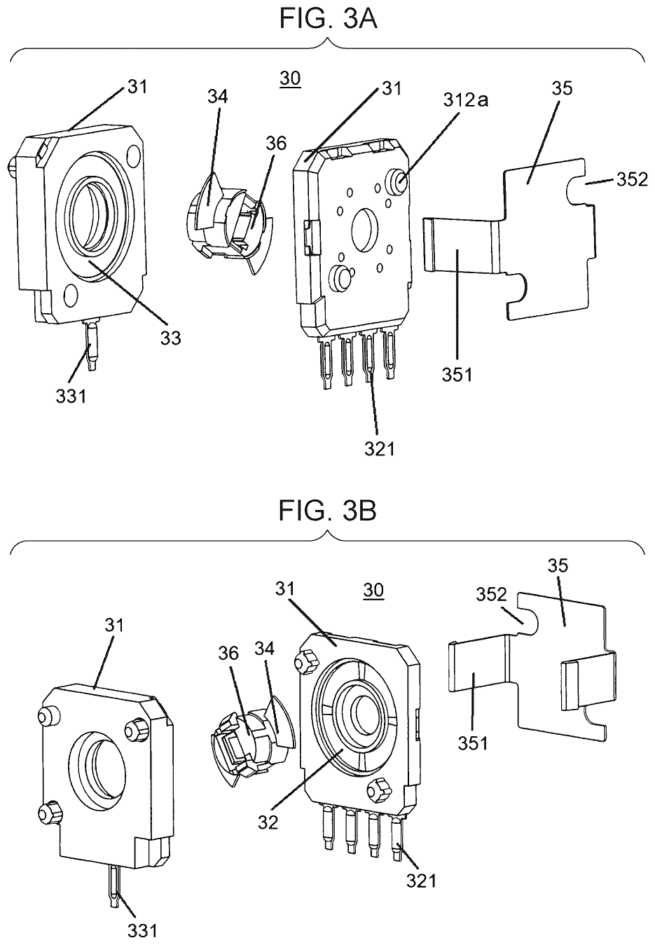

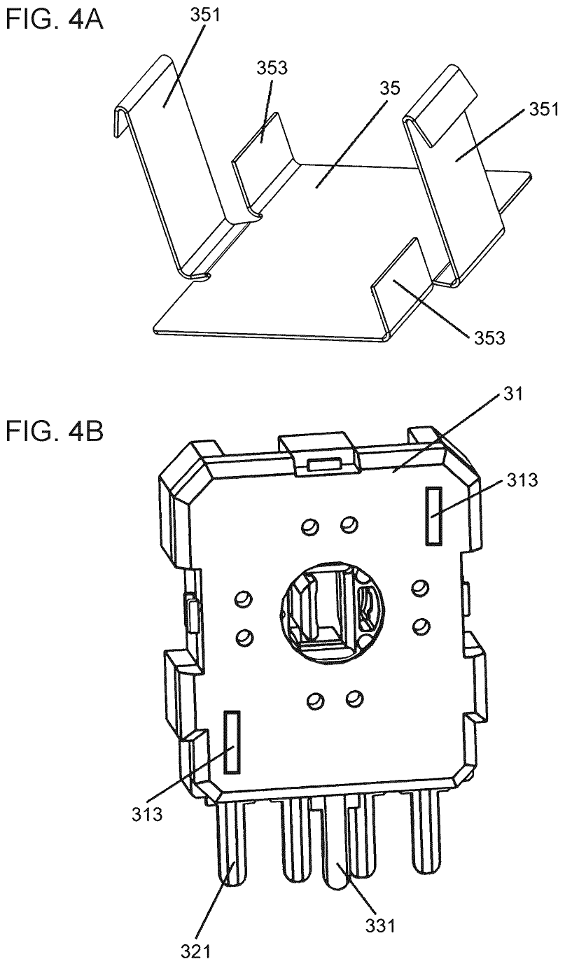

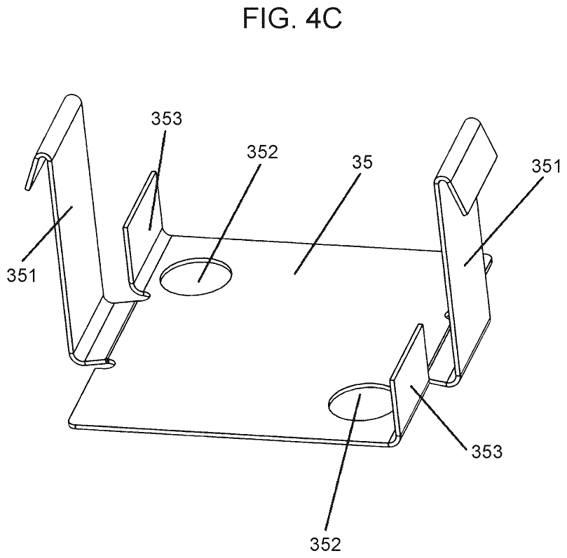

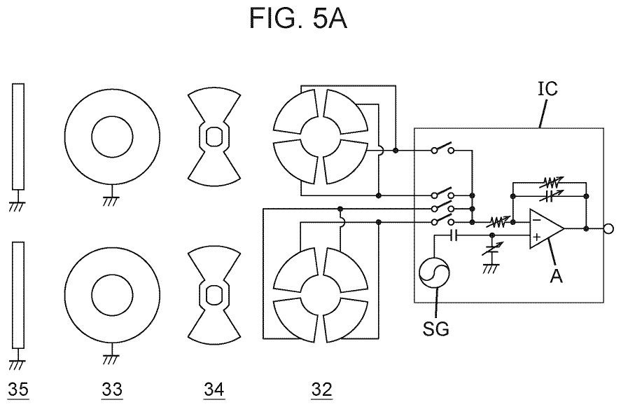

In the following, an input device 1A according to the second embodiment is described, mainly referring to FIGS. 2A to 4C. FIG. 2A is a three-dimensional view of the partial structure of the input device 1A according to the second embodiment of the present disclosure. FIG. 2B is an exploded three-dimensional view of the partial structure of the input device 1A according to the second embodiment of the present disclosure. FIGS. 2C to 2F are exploded three-dimensional views of the rotation detection device of the input device 1A according to the second embodiment of the present disclosure. FIGS. 3A to 3B are schematic diagrams of the fixing structure of the shield plate of the rotation detection device of the input device according to the present disclosure. FIGS. 4A to 4B are schematic diagrams of an example of the positioning structure of the shield plate of the rotation detection device of the input device according to the present disclosure. FIG. 4C is an example of another example of a shield plate of the rotation detection device of the input device according to the present disclosure.

As shown in FIGS. 2A to 2F, the structure of the input device 1A according the second embodiment is different from the structure of the input device 1 according to the first embodiment in that the shield plate 35 of the input device 1A according to the second embodiment includes the mounting leg 351, and the mounting leg 351 engage with the metal frame 11, of the main housing 10, having a bent distal end with the shield plate 35 being connected to the metal frame 11 of the main housing 10.

Specifically, in the input device 1A according to the second embodiment, the metal frame 11 of the main housing 10 has a mounting hole 111 with which the mounting leg 351 of the shield plate 35 is engaged. Here, the situation is shown where the metal frame 11 of the main housing 10 has two mounting holes 111 corresponding to the mounting legs 351 of the shield plate 35, but the present disclosure is not limited to this, and the number of the mounting holes may be set to any number depending on the product standard.

In the input device 1A according to the second embodiment, the shield plate 35 is, for example, made of a metallic material capable of elastic deformation. As shown in FIGS. 2B to 2F, the mounting leg 351 of the shield plate 35 has a bent distal end that is approximately V-shaped in cross-section. Here, two facing mounting legs 351 are provided, but the present disclosure is not limited to this, and the number of the facing mounting legs may be set to any number depending on the product standard. The number of the mounting legs 351 is only required to be the same as the number of mounting holes 111.

In the input device 1A according to the second embodiment, as shown in FIG. 2C, the housing 31 has a recess 312 corresponding to the mounting leg 351 of the shield plate 35 so that the mounting leg 351 of the shield plate 35 is accommodated.

The mounting leg 351 of the shield plate 35 accommodated in the recess 312 of the housing 31 is attached to the metal side plate of the main housing 10 together with other components of the rotation detection member 30 as one of the components of the rotation detection member 30. Specifically, the distal end of the mounting leg 351 of the shield plate 35 is inserted into the mounting hole 111 formed in the metal frame 11 of the main housing 10, and is elastically deformed in the mounting hole 111 to engage with the metal frame 11 of the main housing 10. The mounting leg 351 has a bent distal end and engages with the metal frame 11 of the main housing 10 with the shield plate 35 being connected to the metal frame 11 of the main housing 10. Thus, the mounting leg 351 of the shield plate 35 functions as a member that attaches the rotation detection member 30 to the main housing 10 and further functions as a member that grounds the shield plate 35.

Although not shown in the figure, the mounting leg 351 of the shield plate 35 may have another structure with the mounting function and the grounding function. For example, the mounting leg 351 may also be formed in a long sheet and may have, for example, a U-shaped cut at the distal end. Correspondingly, the metal frame 11 of the main housing 10 has a corresponding slit in into which the mounting leg 351 is inserted. When mounting the rotation detection device 10 on the main housing 10, the mounting leg 351 is inserted into the slit of the metal frame 11 of the main housing 10, and a portion, of the mounting leg 351, surrounded by a U-shaped cut is bent to engage with the metal frame 11 of the main housing 10.

Thus, according to the present embodiment of the input device 1A, the shield plate 35 includes the mounting leg 351, and the mounting leg 351 leg has a bent distal end and engages with the metal frame 11 of the main housing 10 with the shield plate 35 being connected to the metal frame 11 of the main housing 10. This exerts the effects according to the first embodiment. The above mounting leg 351 allows the shield plate 35 to be easily attached, and furthermore, the shield plate 35 is easily grounded while attaching the rotation detection device 30 to the input device 1A, so that the process of assembling the input device 1A can be simplified.

In the input device 1A according to the second embodiment, for example, as shown in FIGS. 2A, 2B, 2C, and 2E, the housing 31 may have a protrusion 312a on the surface of the outer wall on which the shield plate 35 is provided, and the shield plate 35 may have a hole 352 at a position corresponding to the protrusion 312a. Here, the case is shown where there are two protrusions 312a and two holes 352, respectively, but the present disclosure is not limited to this, and each of the number of the protrusions and the number of the holes may be set to any number depending on the product standard. Here, the hole 352 and the protrusion 312a are formed so as to match each other in number and size.

Thus, in the input device 1A according to the second embodiment, the outer wall of the housing 31 has the protrusion 312a and the shield plate 35 has the hole 352 corresponding to the protrusion, so that by fitting the protrusion 312a into the hole 352 when the shield plate 35 is mounted, it is possible to easily achieve positioning of the shield plate 35 and the housing 31, achieve easy mounting of the shield plate 35, and simplifies the process of assembling the input device.

Although FIGS. 2A to 2F show the situation where the hole 352 is a close-hole, the present disclosure is not limited to this, and the hole may have any configuration. For example, as shown in FIGS. 3A and 3B, the hole 352 is an open hole, that is, formed into a cut. Here, the hole 352 and the protrusion 312a are formed so as to match each other in number and size.

The input device 1A according to the second embodiment may be configured so that the shield plate 35 includes a positioning portion 353, as shown in FIG. 4A, and the housing 31 has a positioning hole 313 at a position corresponding to the positioning portion 353, as shown in FIG. 4B. Here, the positioning holes 313 and the positioning portions 353 are formed so as to match each other in number and size.

Thus, in the input device 1A according to the second embodiment, the positioning portion 353 is inserted into the positioning hole 313 when the shield plate 35 is mounted using the positioning portion 353 of the shield plate 35 and the positioning hole 313, of the housing 31, corresponding to the positioning portion 353, so that it is possible to easily achieve positioning of the shield plate 35 and the housing 31, achieve easy mounting of the shield plate 35, and simplify the process of assembling the input device 1A.

The structure of the shield plate 35 is not limited to the above structure. For example, as a modification, as shown in FIG. 4C, the shield plate 35 may have the mounting leg 351, the hole 352, and the positioning portion 353 formed simultaneously.

In the present embodiment, for example, as shown in FIGS. 2C to 2F, the metal movable plate 34 may be insert molded into, for example, a resin-made rotation shaft 36. The rotation shaft 36 has a projection edge at the end, in the axial direction, close to the reference electrode 33. The end of the rotation shaft 36 in the axial direction, the end being closer to the reference electrode 33, contacts an inner circumferential surface P, of the housing 31, covering the reference electrode 33, the inner circumferential surface P being closer to the reference electrode 33, at the inner circumference. The rotation shaft 36 has a plurality of pawls 361 at the end, in the axial direction, closer to the sensor electrode 32, the pawls protruding in the outer circumferential direction. The end of the rotation shaft 36 in the axial direction, the end being closer to the sensor electrode 32, contacts an inner circumferential surface Q, of the housing 31, covering the sensor electrode 33, the inner circumferential surface Q being closer to the sensor electrode 32, at the inner circumference.

### Circuit Connection Structure

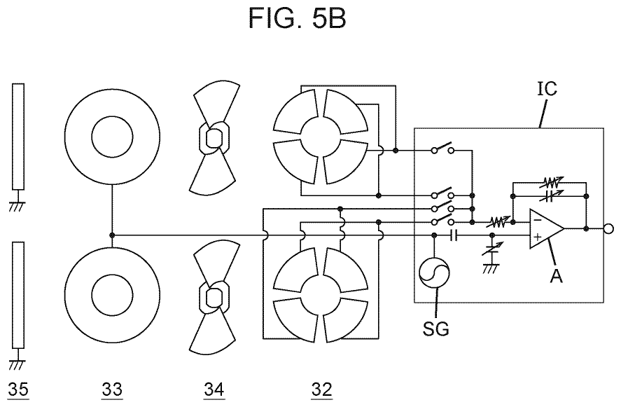

In the first and second embodiments above, the mechanical structure of the input device has been described. In the following, the circuit connection structure of the input device according to the present disclosure is described, mainly referring to FIGS. 5A, 5B, and the like. FIG. 5A is a schematic diagram of an example of the circuit connection structure of the rotation detection device 30 of the input device 1 according to the first embodiment of the present disclosure. FIG. 5B is a schematic diagram of an example of the circuit connection structure of the rotation detection device 30 of the input device 1A according to the second embodiment of the present disclosure.

As shown in FIGS. 1A to 1C and FIG. 5A, the input device 1 according to the first embodiment further includes a measurement IC including an operational amplifier A and an AC signal source S electrically connected to one terminal of the operational amplifier.

The reference electrode 33 as well as the shield plate 35 is grounded. For example, the reference electrode 33 may be grounded through the leg 331.

The sensor electrode 32 is electrically connected to the other terminal of the operational amplifier A. The movable plate 34 is attached to the housing 31 via the resin-made rotation shaft 36 (see FIGS. 1A to 1C) and is not electrically connected to any other members in the circuit. In other words, the movable plate 34 is electrically floating.

Here, the movable plate 34 may be made of, for example, an insulating material with a high dielectric constant, or a synthetic resin or ceramics with a high dielectric constant.

The movable plate 34 may be made of metal. This is because the high conductivity of the metal makes it possible to accurately detect a change in electrostatic capacitance even when the metal is formed thin. In addition, since the metal is thin and easy to process, downsizing and weight reduction can be achieved more easily in a case where the metal is used for the movable plate 34.

According to the input device 1 according to the first embodiment of the present disclosure, the movable plate 34 is attached to the housing 31 via the rotation shaft 36 and is not electrically connected to any other members, thereby being able to eliminate the need for a structure to electrically connect the movable plate 34, simplify the mounting structure of the movable plate 34 and the process of manufacturing and assembling, easily achieve downsizing of the rotation detection device 30 and the input device 1, and reduce costs.

As shown in FIGS. 2A to 4C and 5B, the input device 1A according to the second embodiment further includes a measurement IC including an operational amplifier A and an AC signal source SG electrically connected to one terminal of the operational amplifier.

The reference electrode 33 is electrically connected to one terminal of the operational amplifier A and the AC signal source SG. The sensor electrode 32 is electrically connected to the other terminal of the operational amplifier A.

The movable plate 34 is attached to the housing 31 via the resin-made rotation shaft 36 and is not electrically connected to any other members. In other words, as in the first embodiment, the movable plate 34 is electrically floating in the second embodiment. Here, as in the first embodiment, in the second embodiment, the movable plate 34 may be made of, for example, an insulating material with a high dielectric constant a synthetic resin or ceramics with a high dielectric constant. The movable plate 34 may be made of metal.

According to the input device 1A according to the second embodiment of the present disclosure, the movable plate 34 is attached to the housing 31 via the rotation shaft 36 and is not electrically connected to any other members, thereby being able to eliminate the need for a structure to electrically connect the movable plate 34, simplify the mounting structure of the movable plate 34 and the process of manufacturing and assembling, easily achieve downsizing of the rotation detection device 30 and the input device 1, and reduce costs.

### Shape and Scale Dimensions of Sensor Electrode 32 and Movable Plate 34

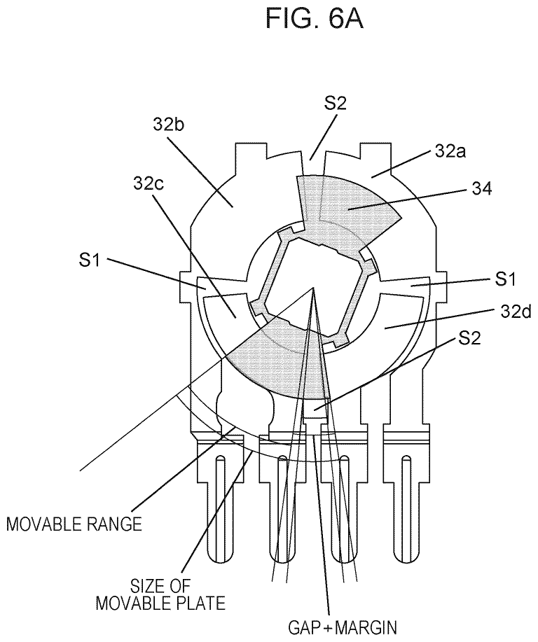

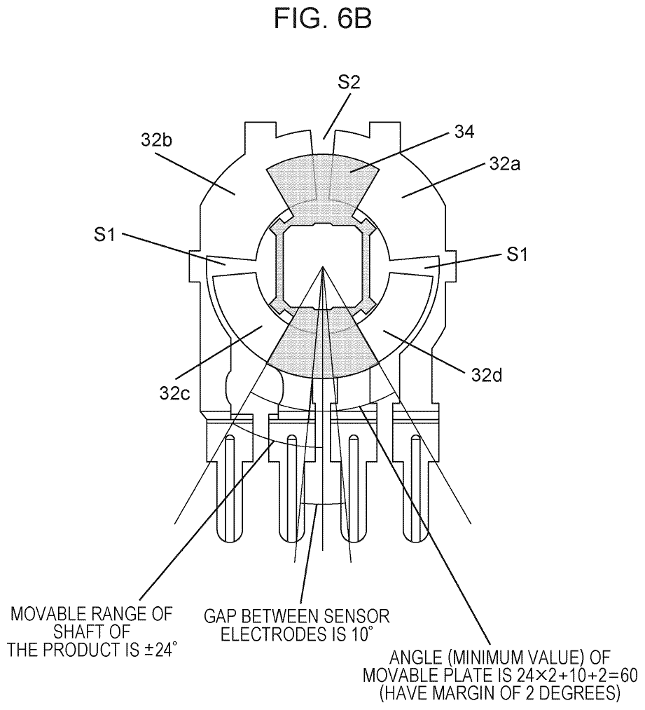

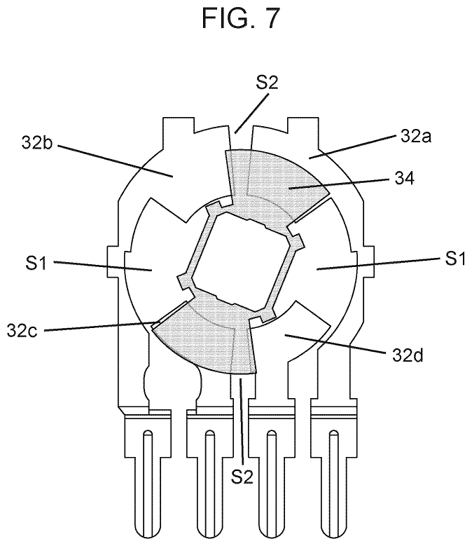

The mechanical structure of the input device according to the present disclosure has been described in the first and second embodiments above. The shape and size of the sensor electrode 32 and the movable plate 34 of the input device according to the present disclosure will be described with reference to FIGS. 6A, 6B and 7. FIGS. 6A and 6B are schematic diagrams of an example of the shape of the sensor electrode of the rotation detection device of the input device according to the present disclosure. FIG. 7 is a schematic diagram of another example of the shape of the sensor electrode of the rotation detection device of the input device according to the present disclosure.

FIG. 6A shows the positioning, structure, shape and size of the sensor electrode 32 and the movable plate 34 of the input device 1A according to the second embodiment of the present disclosure. As shown in FIG. 6A, the sensor electrode 32 includes four annular fan-shaped sub-electrodes 32a, 32b, 32c, and 32d divided from the annular ring. The four sub-electrodes 32a, 32b, 32c and 32d are disposed along the circumference with a gap S between adjacent sub-electrodes. Here, the gap S between adjacent sub-electrodes includes a gap S1 that does not overlap the movable plate 34 and a gap S2 that overlaps the movable plate 34.

Sub-electrodes, of the four sub-electrodes 32a, 32b, 32c and 32d, that are not circumferentially adjacent to each other, are electrically connected to each other. In other words, the sub-electrode 32a and the sub-electrode 32c are electrically connected, and the sub-electrode 32b and the sub-electrode 32d are electrically connected. Here, FIG. 6A shows a situation in which each of the four sub-electrodes has the leg 321. For example, as shown in FIG. 5B, sub-electrodes, of the four sub-electrodes 32a, 32b, 32c and 32d, that are not circumferentially adjacent to each other, are electrically connected to each other using lead wires on the board, and then are required to be connected to one terminal of the operational amplifier A. However, the present disclosure is not limited to this, and sub-electrodes, of the four sub-electrodes 32a, 32b, 32c and 32d, that are not circumferentially adjacent to each other may be electrically connected to each other with one leg 321 shared, as in the input device according to the first embodiment shown in FIG. 1C.

As shown in FIGS. 1C, 2C to 2F, 3A to 3B, 5A to 5B, 6A to 6B, and the like, the movable plate 34 has a shape in which two fan-shaped plates whose arc portions face to each other in opposite directions are connected to each other.

The center angle of the movable plate, that is, the size of the movable plate, is greater than 55° and less than 85°. Specifically, as shown in FIG. 6A, the size of the movable plate is required to be determined by considering the movable range of the operation shaft, the gap S between adjacent sub-electrodes, especially the gap S2 that overlaps the movable plate 34, and the margin angle to eliminate the effects of manufacturing errors.

For example, Expression (1):

$$Size of Movable Plate = Movable Range + Gap S 2 + Margin Angle \qquad ( 1 )$$

Here, the movable range of the operation shaft of the multi-directional input device is limited. In general, this movable range should be greater than 45° and less than 60°.

The gap S between adjacent sub-electrodes should be of a width at which electrostatic capacitance coupling is not transmitted. Specifically, the gap S2 overlapping the movable plate 34 significantly affects the size of the movable plate. Here, it is preferable that the gap be 5° or more and 15° or less. It is preferable that the margin angle be 5° or more and 10° or less.

Thus, according to Expression (1) above, the lower limit of the size of the movable plate should be 55°, since the movable range, the gap, and the margin angle are all made lower limits, that is, the lower limit of the size of the movable plate=45°+5°+5°.

On the other hand, the upper limit of the size of the movable plate should be 85°, since the movable range, the gap, and the margin angle are all set to the upper limit, that is, the upper limit of the size of the movable plate=60°+15°+10°.

For example, as shown in FIG. 6A, the movable range is set at 45°, the gap at 10°, and the margin angle at 5°. Therefore, the center angle of the movable plate 34=45°+10°+5°=60°.

As an example, for example, as shown in FIG. 6B, the movable range is set to ±24°, that is, (24*2)°, the gap S is, for example, 10°, and the margin angle is 2°. Thus, the center angle of the sub-electrode is 80°. The size of the movable plate 34 should be (24*2)°+10°+2°, that is, 60°. Thus, it is possible to make the size of the movable plate 34 appropriate, improve the accuracy of the measurement, reduce costs, and easily achieve downsizing of the device.

The closer to zero the minimum value of the angle at which the movable plate 34 and the sensor electrode 32 overlap with each other is, the better the accuracy of the measurement.

In the input device according to the present disclosure, the gap S between adjacent sub-electrodes may include, for example, the gap S1 that does not overlap the movable plate 34 and the gap S2 that overlaps the movable plate 34. It is preferred that the gap S1 that does not overlap the movable plate 34 be larger than the gap S2 that overlaps the movable plate.

Specifically, for example, as shown in FIG. 7, the maximum value of the gap S1 that does not overlap the movable plate 34 may be as expressed by Expression (2).

That is, Expression (2):

$$Maximum Value of Gap S 1 that does not overlap Movable Plate 34 = 180 ° - Lower Limit of Size of Movable Plate - Lower Limit of Movable Range - Lower Limit of Margin Angle \qquad ( 2 )$$

In a case where the lower limit of the size of the movable plate 34 is set to 55°, the lower limit of the movable range is set to 45°, and the lower limit of the margin angle is set to 5°, the maximum value of the gap S1 that does not overlap the movable plate 34=180°−55°−45°−5°=75°. The larger the gap S1, the more accurate the measurement.

When the requirements for measurement accuracy are not high, the center angle of the movable plate 34 may be 90°.

Thus, according to the input device according to the present disclosure, by adjusting the movable plate 34 to the appropriate size or the size of the gap S based on the accuracy requirements and other factors, it is possible to improve the accuracy of measurement, reduce costs, and easily achieve downsizing of the device.

### Composition of Sensor Electrode 32 and Reference Electrode 33

As shown in FIGS. 1B and 1C, in the input device 1 according to the first embodiment of the present disclosure, for example, the sensor electrode 32 may be insert molded into the housing 31 so that the annular inner edge and the annular outer edge of a surface opposite a surface facing the movable plate 34 and the surface facing the movable plate 34 are covered by the housing 31.

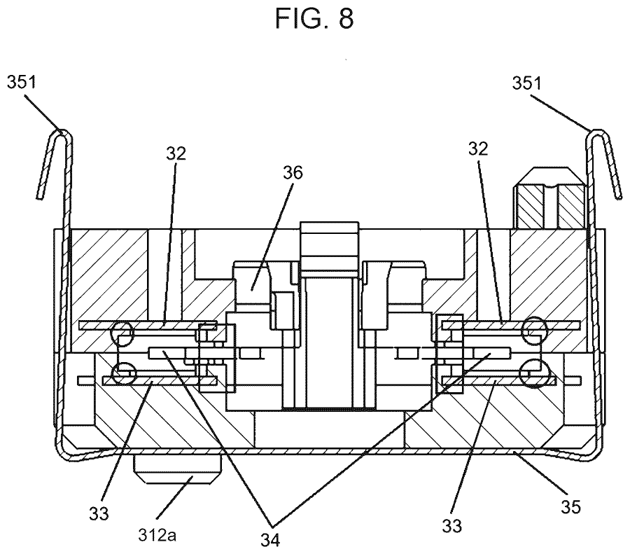

As shown in FIGS. 2C, 2D, and 8, in the input device 1A according to the second embodiment of the present disclosure, for example, the sensor electrode 32 may be insert molded into the housing 31 so that the annular inner edge (indicated by a frame in FIG. 8) and the annular outer edge (indicated by a circle in FIG. 8) of a surface opposite a surface facing the movable plate 34 and the surface facing the movable plate 34 are covered by the housing 31. The reference electrode 33 is an annular metal plate, and the reference electrode 33 is inserted into the housing 31 so that the annular inner edge (indicated by a frame in FIG. 8) and the annular outer edge (indicated by a circle in FIG. 8) of a surface opposite a surface facing the movable plate 34 and the surface facing the movable plate are covered by the housing 31.

Thus, according to the input devices according to the first and second embodiments of the present disclosure, since the sensor electrode 32 and/or the reference electrode 33 are insert molded into the resin-made housing 31 so as to be partially exposed, the sensor electrode 32 and/or the reference electrode 33 can be stably fixed to the housing 31 without the need for screws or other fixing materials, thereby reducing the number of members and costs, facilitating the process of manufacturing and assembling, hardly generating noise, making the position of the sensor electrode 32 and/or the reference electrode 33 stable, and capable of performing measurement with high accuracy of and excellent stability.

In the input device 1 according to the first embodiment of the present disclosure, for example, a half or more of an area of a surface, of the sensor electrode 32, facing the movable plate 34 may not be covered by the housing 31.

In the input device 1A according to the second embodiment of the present disclosure, for example, a half or more of an area of a surface, of the sensor electrode 32, facing the movable plate 34 may not be covered by the housing 31. A half or more of an area of a surface, of the reference electrode 33, facing the movable plate 34 is not covered by the housing 31.

Thus, according to the input device according to the first and second embodiments of the present disclosure, since a half or more of an area of the sensor electrode 32 and/or the reference electrode 33 is fixed to the mold during insert molding, the position of each of the sensor electrode 32 and/or the reference electrode 33 is stable, noise is hardly generated, and measurement with high accuracy of and excellent stability can be performed.

As shown in FIGS. 1B and 1C, in the input device 1 according to the first embodiment of the present disclosure, for example, the thickness of the housing 31 covering the annular inner edge of a surface of the sensor electrode 32, the surface facing the movable plate 34 in the direction along the rotation shaft 36 may be greater than the thickness of the housing 31 covering the annular outer edge of the surface of the sensor electrode 32, the surface facing the movable plate 34.

As shown in FIG. 2C, FIG. 2D and FIG. 8, in the input device 1A according to the second embodiment of the present disclosure, for example, the thickness (indicated by a frame in FIG. 8) of the housing 31 covering the annular inner edge of a surface of the sensor electrode 32, the surface facing the movable plate 34 in the direction along the rotation shaft 36 may be greater than the thickness (indicated by a circle in FIG. 8) of the housing 31 covering the annular outer edge of the surface of the sensor electrode 32, the surface facing the movable plate 34. In the direction along the rotation shaft 36, the thickness (indicated by a frame in FIG. 8) of the housing 31 covering the annular inner edge of a surface of the reference electrode 33, the surface facing the movable plate 34 is greater than the thickness (indicated by a circle in FIG. 8) of the housing 31 covering the annular outer edge of the surface of the reference electrode 33, the surface facing the movable plate 34.

Thus, according to the input device according to the first and second embodiments of the present disclosure, by making the thickness of the housing 31 covering the annular inner edge larger than the thickness of the housing 31 covering the annular outer edge, it is possible to securely hold the movable plate 35, prevent the axial movement of the movable plate, and prevent contact between the movable plate and other resin components.

According to the input device according to the first and second embodiments of the present disclosure, for example, as shown in FIGS. 1A to 1C and FIGS. 2A to 2F, the metal frame 11 of the main housing 10 may be grounded and the sensor electrode 32 may be disposed closer to the main housing 10 than the reference electrode 33. However, the present disclosure is not limited to this, and, for example, as shown in FIGS. 3A to 3B, the reference electrode 33 may be disposed closer to the main housing 10 than the sensor electrode 32.

Thus, according to the input devices according to the first and second embodiments of the present disclosure, the main housing 10 is securely grounded and the sensor electrode 32 is disposed closer to the securely grounded main housing 10, further improving the accuracy of the measurement.

### Third Embodiment

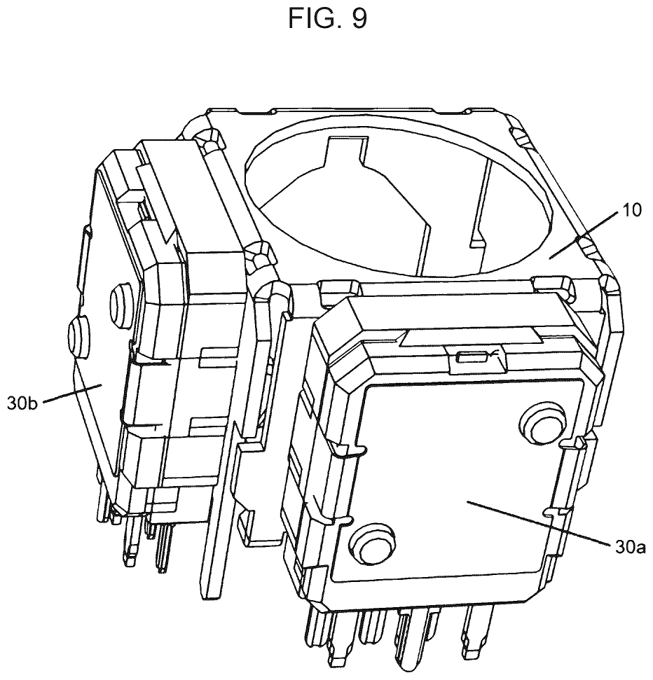

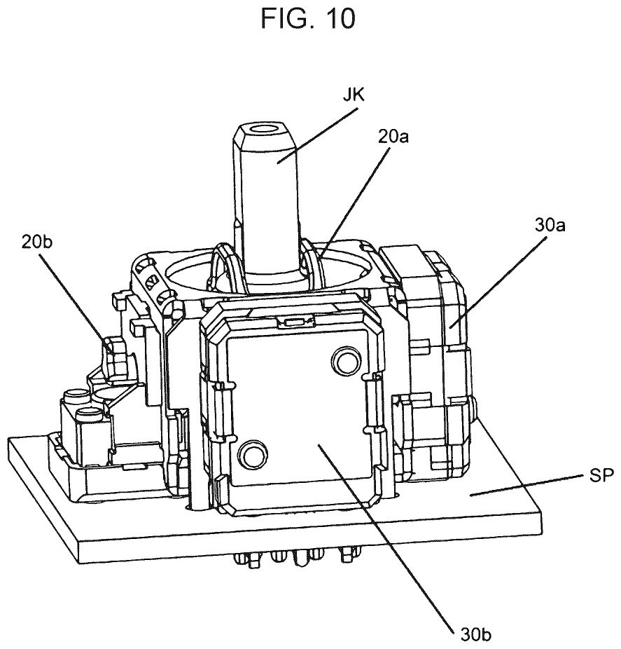

The specific structure of each member in the first embodiment and the second embodiment and has been described above. In the following, the input device according to the third embodiment of the present disclosure is described, mainly referring to FIGS. 9 to 10.

FIG. 9 is a three-dimensional view of a partial structure of an input device 1B according to the third embodiment of the present disclosure. FIG. 10 is a three-dimensional view of an example of the partial structure of the input device 1B according to the present disclosure.

As shown in FIGS. 9 to 10, in the input device 1B according to the third embodiment of the present disclosure, for example, the interlocking unit 20 may include a first interlocking unit 20a pivotably provided in the main housing 10 and a second interlocking unit 20b pivotably provided in the main housing 10 in a direction orthogonal to the first interlocking unit 20a. The rotation detection device 30 includes a first rotation detection device 30a that detects the rotation angle of the first interlocking unit 20a and a second rotation detection device 30b that detects the rotation angle of the second interlocking unit 20b.

Here, the first interlocking unit 20a, the second interlocking unit 20b, the first rotation detection device 30a, and the second rotation detection device 30b may have the structures according to the first and second embodiments described above, and detailed descriptions are omitted.

Thus, according to the input device 1B for the third embodiment, movements in a plurality of directions can be detected with high accuracy.

Although several embodiments of the present disclosure have been described, these embodiments are shown by way of example and are not intended to limit the scope of the present disclosure. These embodiments can be implemented in various other forms, and various omissions, substitutions, and changes can be made without departing from the gist of the disclosure. These embodiments and modifications thereof are included in the scope and gist of the disclosure and in the scope of the disclosure described in the technical proposal and its equivalents.

For example, the rotation detection device according to the present disclosure may include a housing, a sensor electrode provided in the housing, a movable plate rotatably provided in the housing, and an annular reference electrode, wherein the sensor electrode may include four annular fan-shaped sub-electrodes divided from an annular ring, wherein the four sub-electrodes may be disposed along a circumference with a gap between adjacent sub-electrodes, wherein sub-electrodes, of the four sub-electrodes, that are not circumferentially adjacent to each other may be electrically connected to each other, wherein the movable plate may have a shape in which two fan-shaped plates whose arc portions face to each other in opposite directions are connected to each other, wherein a center angle of the movable plate is greater than 55° and less than 85°, wherein a gap between adjacent sub-electrodes may include a gap that does not overlap the movable plate and a gap that overlaps the movable plate, and wherein the gap that does not overlap the movable plate may be larger than the gap that overlaps the movable plate.

As a result, it is possible to make the size of the movable plate appropriate, improve the accuracy of the measurement, reduce costs, and easily achieve downsizing of the device.

The rotation detection device according to the present disclosure, for example, may include a housing, a sensor electrode provided in the housing, a movable plate rotatably provided in the housing, and an annular reference electrode, wherein the sensor electrode may include four annular fan-shaped sub-electrodes divided from an annular ring, wherein the four sub-electrodes are disposed along a circumference with a gap between adjacent sub-electrodes, wherein sub-electrodes, of the four sub-electrodes, that are not circumferentially adjacent to each other may be electrically connected to each other, wherein the movable plate has a shape in which two fan-shaped sub-electrodes whose arc portions face to each other in opposite directions may be connected, wherein the reference electrode may be insert molded into the housing so that a surface, of the reference electrode, opposite a surface, of the reference electrode, facing the movable plate and an annular inner edge and an annular outer edge of the surface facing the movable plate are covered by the housing, and wherein the sensor electrode may be insert-molded into the housing so that a surface, of the sensor electrode, opposite a surface, of the sensor electrode, facing the movable plate and an annular inner edge and an annular outer edge of the surface facing the movable plate are covered by the housing.

According to the rotation detection device according to the present disclosure above, the reference electrode and the sensor electrode are insert molded into a resin-made housing so as to be partially exposed, the reference electrode and the sensor electrode can be stably fixed to the housing without the need for screws or other fixing materials, thereby reducing the number of members and costs and facilitating the process of manufacturing and assembling, hardly generating noise, making the position of the reference electrode and/or the sensor electrode stable, and capable of performing measurement with high accuracy of and excellent stability.

1. An input device comprising:
a main housing including a metal side plate;
an interlocking unit pivotably provided in the main housing; and
a rotation detection device configured to detect a rotation angle of the interlocking unit, wherein the rotation detection device includes:
a housing;
a sensor electrode provided in the housing;
a reference electrode facing the sensor electrode;
a movable plate rotatably provided in the housing and disposed between the sensor electrode and the reference electrode; and
a shield plate provided on an outer wall of the housing, the shield plate being connected to the metal side plate of the main housing.

2. The input device according to claim 1, wherein the shield plate includes a mounting leg having, a bent distal end which engages with the metal side plate of the main housing, whereby the shield plate is connected to the metal side plate.

3. The input device according to claim 1, wherein the housing has a protrusion on a surface of the outer wall on which the shield plate is provided, while the shield plate has a hole at a position corresponding to the protrusion.

4. The input device according to claim 1, wherein the shield plate includes a positioning portion, while the housing has a positioning hole at a position corresponding to the positioning portion.

5. The input device according to claim 1, further comprising:
a measurement IC including:
an AC signal source; and
an operational amplifier,
wherein the reference electrode is electrically connected to one terminal of the operational amplifier and the AC signal source, while the sensor electrode is electrically connected to the other terminal of the operational amplifier,
and wherein the movable plate is attached to the housing via a resin-made rotation shaft, the movable plate not being electrically connected to any other members.

6. The input device according to claim 1, further comprising:
a measurement IC including:
an operational amplifier; and
an AC signal source electrically connected to one terminal of the operational amplifier,
wherein the reference electrode is grounded, while the sensor electrode is electrically connected to the other terminal of the operational amplifier,
and wherein the movable plate is attached to the housing via a resin-made rotation shaft, the movable plate not being electrically connected to any other members.

7. The input device according to claim 5,
wherein the sensor electrode includes four annular fan-shaped sub-electrodes arranged along a circumference to form a divided annular ring, with gaps each provided between adjacent sub-electrodes, a pair of the sub-electrodes, that are not circumferentially adjacent to each other are electrically connected to each other,
wherein the movable plate has two fan-shaped plates which are connected to each other and extending outwardly in opposite directions,
and wherein a center angle of each fan-shaped plate is greater than 55° and smaller less than 85°.

8. The input device according to claim 7,
wherein the gaps include a first gap that does not overlap the movable plate and a second gap that overlaps the movable plate in a plan view from a direction parallel to the rotation shaft,
and wherein the first gap is greater larger than the second gap.

9. The input device of claim 7,
wherein the sensor electrode has a first surface facing the movable plate and a second surface opposite to the first surface,
and wherein the sensor electrode is insert molded into the housing such that the second surface, and an annular inner edge and an annular outer edge of the first surface are covered by the housing.

10. The input device according to claim 7,
wherein the reference electrode is an annular metal plate having a first surface facing the movable plate and a second surface opposite to the first surface,
and wherein the reference electrode is insert molded into the housing such that the second surface, and an annular inner edge and an annular outer edge of the first surface are covered by the housing.

11. The input device according to claim 9, wherein a half or more of an area of the first surface, is not covered by the housing.

12. The input device according to claim 10, wherein a half or more of an area of the first surface, is not covered by the housing.

13. The input device according to claim 9, wherein a thickness of a portion of the housing covering the annular inner edge of the first surface, in a direction along the rotation shaft is greater than a thickness of a portion of the housing covering the annular outer edge of the first surface.

14. The input device according to claim 10, wherein a thickness of a portion of the housing covering the annular inner edge of the first surface, in a direction along the rotation shaft is greater than a thickness of a portion of the housing covering the annular outer edge of the first surface.

15. The input device according to claim 1,
wherein the metal side plate of the main housing is grounded,
and wherein the sensor electrode is disposed closer to the main housing than the reference electrode.

16. The input device according to claim 1,
wherein the interlocking unit includes:
a first interlocking unit pivotable in a first direction; and
a second interlocking unit pivotable in a second direction orthogonal to the first direction,
and wherein the rotation detection device includes:
a first rotation detection device that detects a rotation angle of the first interlocking unit; and
a second rotation detection device that detects a rotation angle of the second interlocking unit.

17. A rotation detection device, comprising:
a housing;
a sensor electrode provided in the housing;
a movable plate rotatably provided in the housing; and
an annular reference electrode,
wherein the sensor electrode includes four annular fan-shaped sub-electrodes arranged along a circumference to form a divided annular ring, with gaps each provided a gap between adjacent sub-electrodes, a pair of the sub-electrodes, that are not circumferentially adjacent to each other are electrically connected to each other,
wherein the movable plate has two fan-shaped plates which are connected to each other and extending outwardly in opposite directions,
wherein a center angle of each fan-shaped plate is greater than 55° and smaller than 85°,
wherein the gaps include a first gap that does not overlap the movable plate and a second gap that overlaps the movable plate in a plan view from a direction parallel to the rotation shaft,
and wherein the first gap is greater than the second gap.

18. A rotation detection device, comprising:
a housing;
a sensor electrode provided in the housing;
a movable plate rotatably provided in the housing; and
an annular reference electrode having a first surface facing the movable plate and a second surface opposite to the first surface,
wherein the sensor electrode includes four annular fan-shaped sub-electrodes arranged along a circumference to form a divided annular ring, with gaps each provided between adjacent sub-electrodes, a pair of the sub-electrodes, that are not circumferentially adjacent to each other are electrically connected to each other,
wherein the movable plate has two fan-shaped sub-electrodes which are connected to each other and extending outwardly in opposite directions,
wherein the reference electrode is insert molded into the housing such that the second surface, and an annular inner edge and an annular outer edge of the first surface are covered by the housing,
wherein the sensor electrode has a third surface facing the movable plate and a fourth surface opposite to the third surface,
and wherein the sensor electrode is insert-molded into the housing such that the fourth surface, and an annular inner edge and an annular outer edge of the third surface are covered by the housing.
